(19) United States
(12) Patent Application Publication
(10) Pub. No.: US 2020/0202604 A1
(43) Pub. Date: Jun. 25, 2020

(54) SYSTEM AND METHOD FOR EXTRACTING CHARACTERISTICS FROM A DIGITAL PHOTO AND AUTOMATICALLY GENERATING A THREE-DIMENSIONAL AVATAR

(71) Applicant: IMVU, Inc., Redwood City, CA (US)

(72) Inventors: Robert Rui OTANI, San Jose, CA (US); Xuanyu ZHONG, Mountain View, CA (US); Tony Sin-Yu PENG, Foster City, CA (US)

(21) Appl. No.: 16/228,314

(22) Filed: Dec. 20, 2018

(51) Int. Cl. G06T 13/40; G06K 9/00

(52) U.S. Cl. CPC G06T 13/40; G06K 9/00281; G06K 9/00228

(57) ABSTRACT

A method and apparatus are disclosed for generating an avatar from an image of a face using an avatar generation engine executed by a processing unit of a computing device. The avatar generation engine receives the image, identifies a face in the image, crops a face in the image to generate a cropped face image, detects facial landmarks in the cropped face image, determines an ethnicity and a gender based on the cropped face image, selects a base facial rig from a set of stored facial rigs based on one or more of ethnicity, gender, hairstyle, skin color, hair color, body hair, presence of eyeglasses, presence of a hat, and presence of lipstick, alters the base facial rig based on the facial landmarks to generate a customized facial rig, and adds facial attributes to the customized facial rig based on the facial characteristics to generate the avatar.

### TECHNICAL FIELD

A method and apparatus are disclosed for automatically generating a three-dimensional avatar from an image of a face in a digital photo.

### BACKGROUND OF THE INVENTION

The prior art includes various approaches for performing facial analysis of digital photos of human faces. For example, researchers at Carnegie-Mellon University generated the CMU Multi-PIE dataset, which contains a hundreds of images of human faces in a variety of lighting conditions with groundtruth landmark annotations. The annotations in the CMU Multi-PIE dataset indicate the location of certain facial characteristics, such as eyebrow position within a facial image.

FIG. 1 depicts an example of a prior art method 100 for generating this type of data. Image 101 is analyzed. Various features in image 101 are identified and their relative positioning within the frame of image 101 is determined and stored, resulting in facial dataset 102. Facial dataset 102 identifies the general shape and location of facial features such as eyes, eyebrows, nose, and mouth for the person depicted in image 101.

The prior art also includes computer-generated avatars. An avatar is a graphical representation of a user. Avatars sometimes are designed to be an accurate and realistic representation of the user, and sometimes they are designed to look like a character that does not resemble the user. Applicant is a pioneer is in the area of avatar generation in virtual reality (VR) applications. In these applications, a user can generate an avatar and then interact with a virtual world, including with avatars operated by other users, by directly controlling the avatar.

FIG. 2 depicts avatar 200, which is an example of a prior art avatar. In the prior art, it often can be a very tedious and lengthy process for a user to create an avatar that resembles the user. Typically, the user is provided a set of basic avatars as a starting point. This set of basic avatars is used as the starting point for all users and are not customized in any way for the user. If the user is attempting to create an avatar that closely resembles the user, the user will select the basic avatar that he or she thinks is the closest match to the user. This is an error-prone process, as users often do not have an accurate impression of their own appearance and because it can be difficult for a user to accurately identify the avatar that is the best fit from among a large number of basic avatars. Once the user selects a basic avatar, he or she must then make adjustments to dozens of feature in the avatar, such as hair style, hair color, eye shape, eye color, eye location, nose shape, nose location, eyebrow shape, eyebrow color, eyebrow location, mouth shape, mouth color, mouth location, skin color, etc. This can be a very long and tedious process, and the user often is frustrated at the end of the process because the customized avatar may not look like the user.

What is needed is a mechanism for automatically generating an avatar based on a face contained in a digital photo.

### SUMMARY OF THE INVENTION

A method and apparatus are disclosed for generating an avatar from an image of a face using an avatar generation engine executed by a processing unit of a computing device. The avatar generation engine receives the image, identifies a face in the image, crops a face in the image to generate a cropped face image, determines an ethnicity and a gender based on the cropped face image, detects facial landmarks in the cropped face image, selects a base facial rig from a set of stored facial rigs based on ethnicity and gender, alters the base facial rig based on the facial landmarks to generate a customized facial rig, and adds facial attributes to the customized facial rig based on the facial characteristics to generate the avatar.

### BRIEF DESCRIPTION OF THE DRAWINGS

FIG. 1 depicts an example of a prior art process for extracting facial features from a photo of a human face.

FIG. 2 depicts an example of a prior art avatar.

FIG. 3 depicts hardware components of a client device.

FIG. 4 depicts software components of the client device.

FIG. 5 depicts a plurality of client devices in communication with a server.

FIG. 6 depicts an avatar generation engine.

FIG. 7A depicts an avatar generation method performed by the avatar generation engine.

FIGS. 7B-7G depict certain images and structures generated during the avatar generation method of FIG. 7A.

FIG. 7H depicts, on a single page, certain images and structures generated during the avatar generation method of FIG. 7A.

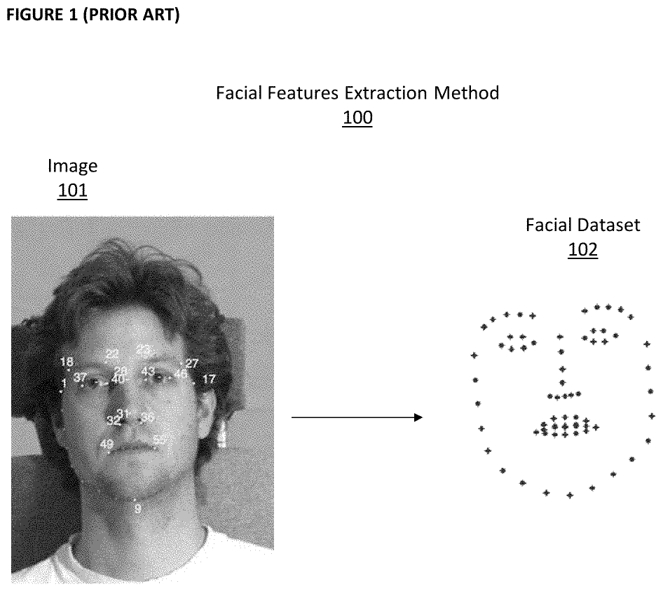

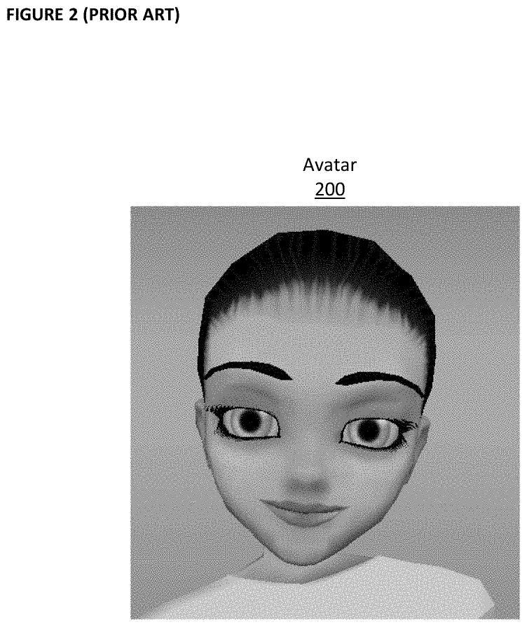

### DETAILED DESCRIPTIONS OF THE PREFERRED EMBODIMENTS

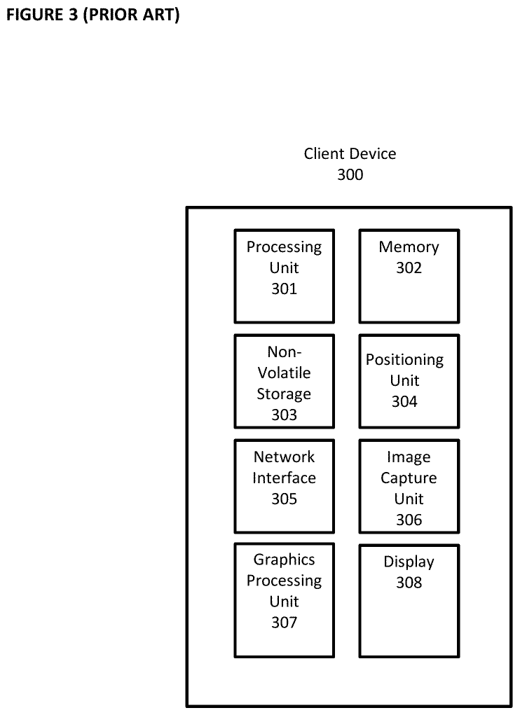

FIG. 3 depicts hardware components of client device 300. These hardware components are known in the prior art. Client device 300 is a computing device that comprises processing unit 301, memory 302, non-volatile storage 303, positioning unit 304, network interface 305, image capture unit 306, graphics processing unit 307, and display 308. Client device 300 can be a smartphone, notebook computer, tablet, desktop computer, gaming unit, wearable computing device such as a watch or glasses, or any other computing device.

Processing unit 301 optionally comprises a microprocessor with one or more processing cores that can execute instructions. Memory 302 optionally comprises DRAM or SRAM volatile memory. Non-volatile storage 303 optionally comprises a hard disk drive or flash memory array. Positioning unit 304 optionally comprises a GPS unit or GNSS unit that communicates with GPS or GNSS satellites to determine latitude and longitude coordinates for client device 300, usually output as latitude data and longitude data. Network interface 305 optionally comprises a wired interface (e.g., Ethernet interface) and/or a wireless interface (e.g., an interface that communicates using the 3G, 4G, 5G, GSM, or 802.11 standards or the wireless protocol known by the trademark BLUETOOTH, etc.). Image capture unit 306 optionally comprises one or more standard cameras (as is currently found on most smartphones and notebook computers). Graphics processing unit 307 optionally comprises a controller or processor for generating graphics for display. Display 308 displays the graphics generated by graphics processing unit 307 and optionally comprises a monitor, touchscreen, or other type of display.

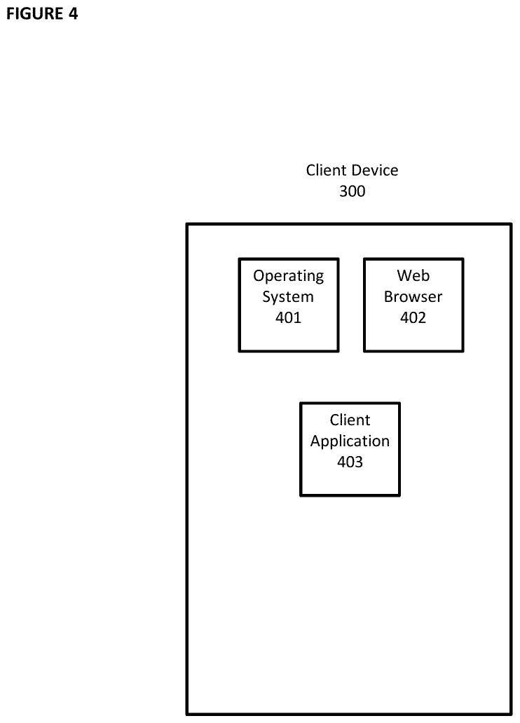

FIG. 4 depicts software components of client device 300. Client device 300 comprises operating system 401 (such as one of the operating systems known by the trademarks WINDOWS, LINUX, ANDROID, iOS, or others), web browser 402 (such as one of the web browsers known by the trademarks CHROME, SAFARI, INTERNET EXPLORER, or others), and client application 403.

Client application 403 comprises lines of software code executed by processing unit 301 and/or graphics processing unit 307 to perform the functions described below. For example, client device 300 can be a smartphone sold with the trademark “GALAXY” by Samsung or “IPHONE” by Apple, and client application 403 can be a downloadable app installed on the smartphone. Client device 300 also can be a notebook computer, desktop computer, game system, or other computing device, and client application 403 can be a software application running on client device 300. Client application 403 forms an important component of the inventive aspect of the embodiments described herein, and client application 403 is not known in the prior art.

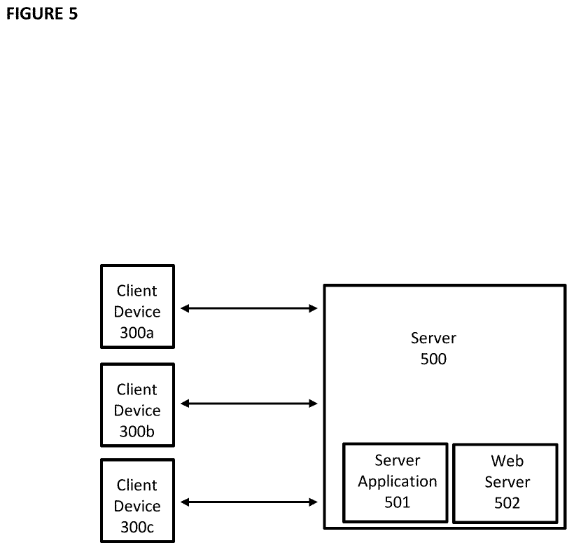

With reference to FIG. 5, three instantiations of client device 300 are shown, client devices 300a, 300b, and 300c. These are exemplary devices, and it is to be understood that any number of different instantiations of client device 300 can be used. Client devices 300a, 300b, and 300c each communicate with server 500 using network interface 305.

Server 500 is a computing device, and it includes the same or similar hardware components as those shown in FIG. 3 for client device 300. In the interest of efficiency, those components will not be described again, and it can be understood that FIG. 3 depicts exemplary hardware components for server 500 as well as for client device 300. Server 500 runs server application 501. Server application 501 comprises lines of software code that are designed specifically to interact with client application 220. Server 500 also runs web server 502, which comprises lines of software code to operate a web site accessible from web browser 402 in client devices 300a, 300b, and 300c.

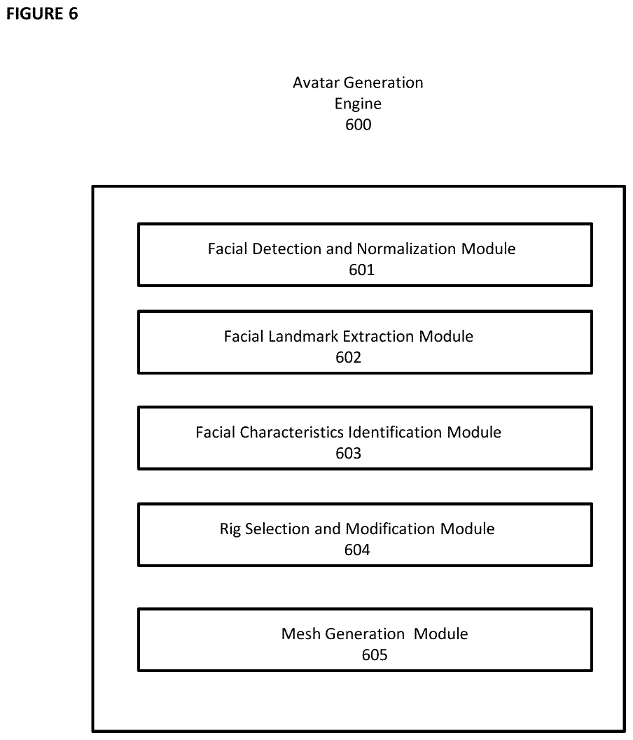

FIG. 6 depicts avatar generation engine 600. Avatar generation engine 600 comprises lines of software code that resides wholly within client application 403, wholly within server application 501, or is split between client application 403 and server application 501. In the latter situation, the functions described below for avatar generation engine 600 are distributed between client application 403 and server application 501.

Avatar generation engine 600 comprises facial detection and normalization module 601, facial landmark extraction module 602, facial characteristics identification module 603, rig selection and modification module 604, and mesh selection module 605. Facial detection and normalization module 601, facial landmark extraction module 602, facial characteristics identification module 603, rig selection and modification module 604, and mesh selection module 605 each comprises lines of software code executed by processing unit 301 and/or graphics processing unit 307 in client device 300 and/or server 500 to perform the functions described below

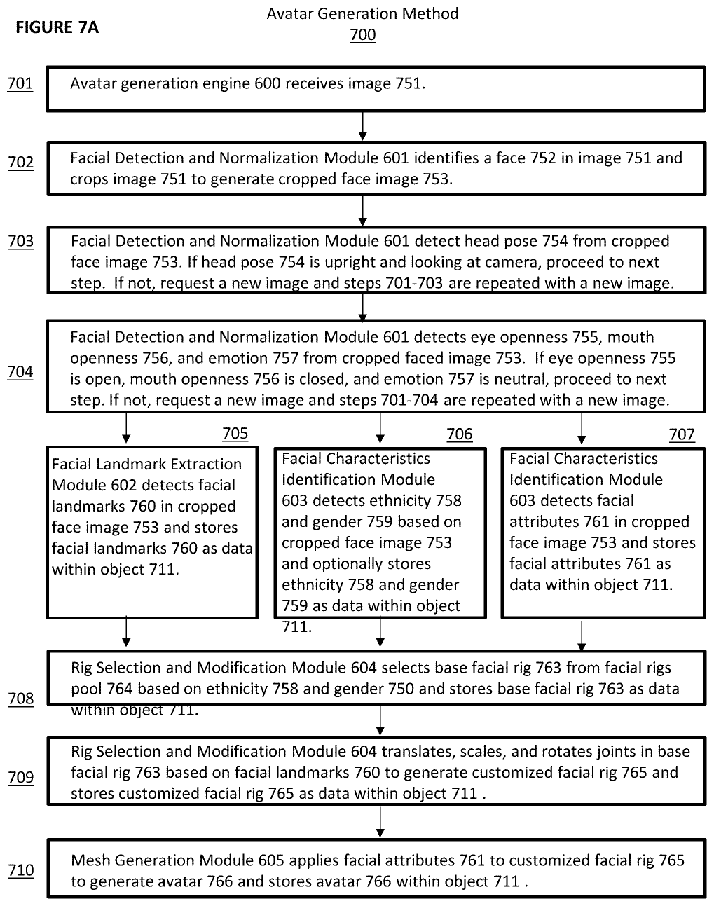

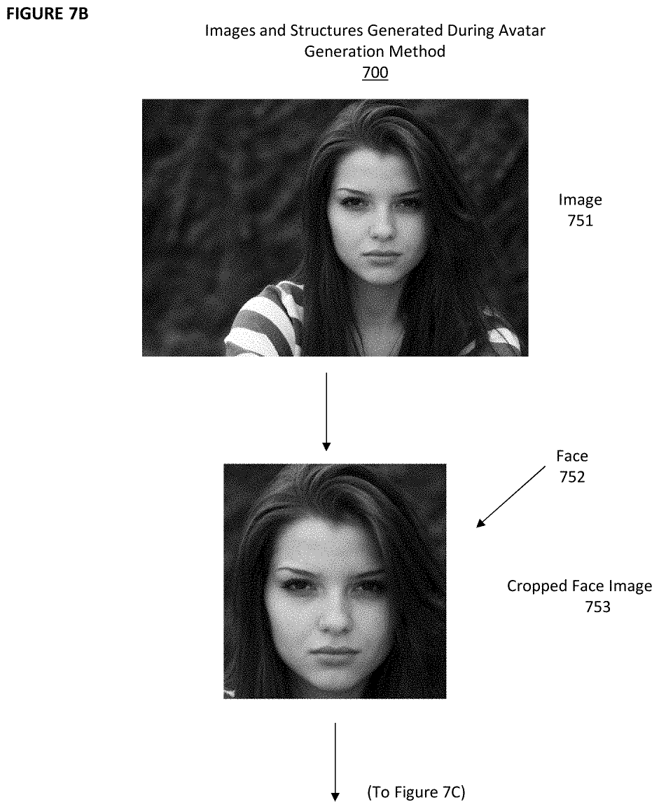

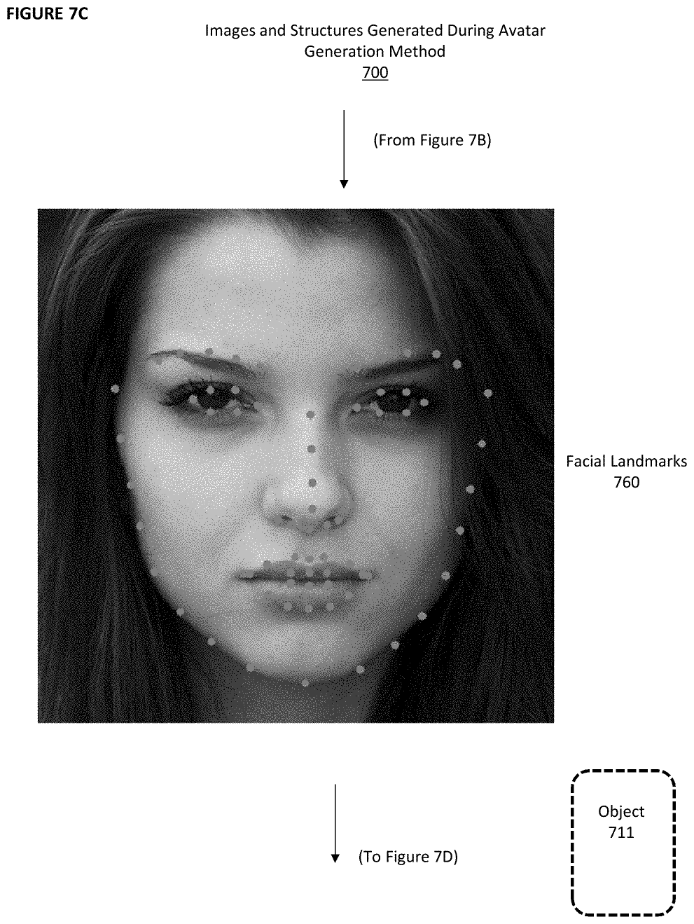

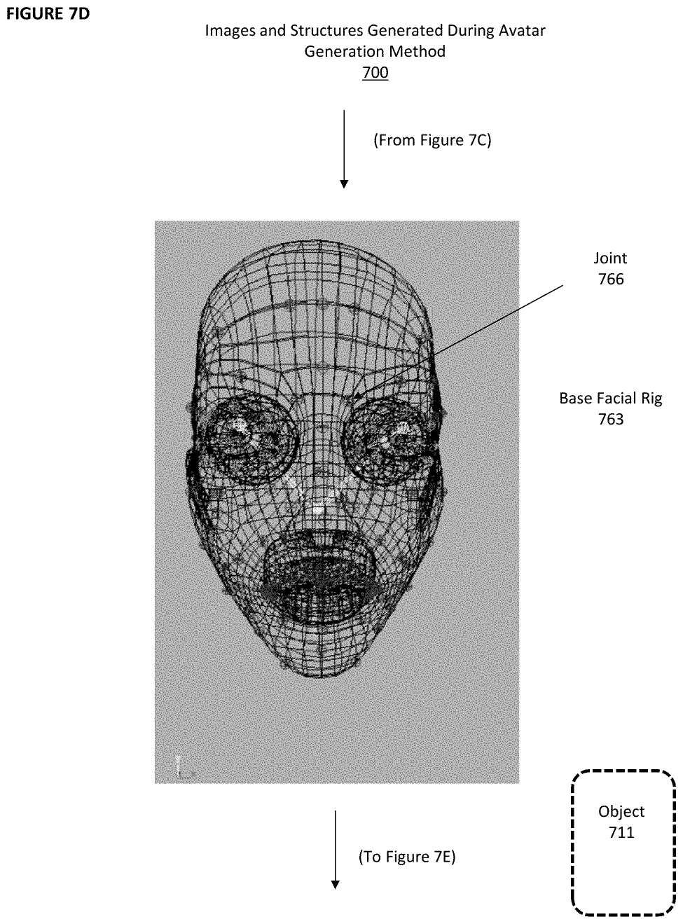

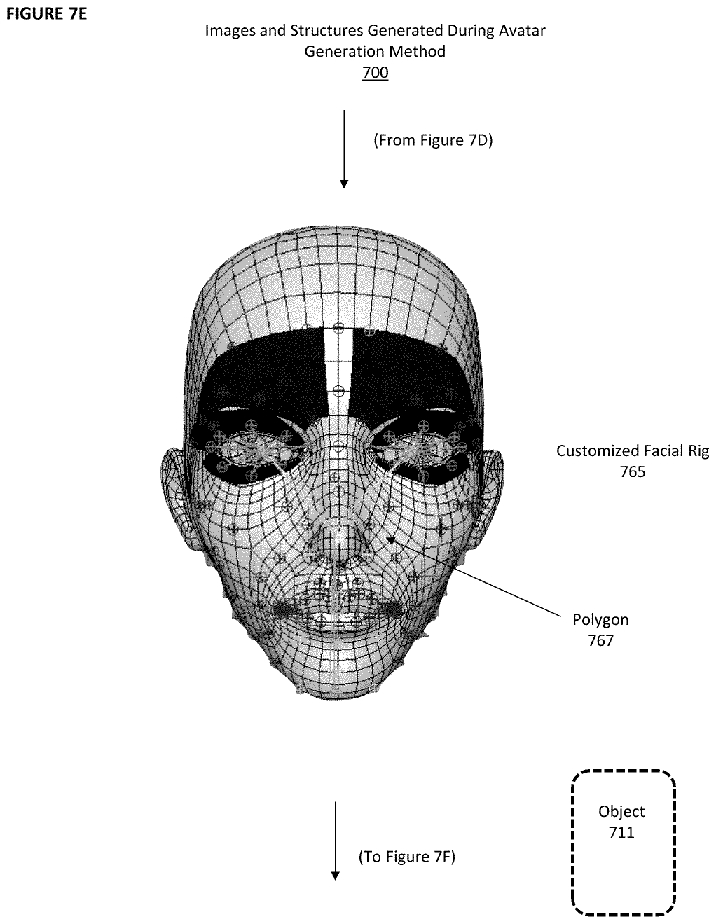

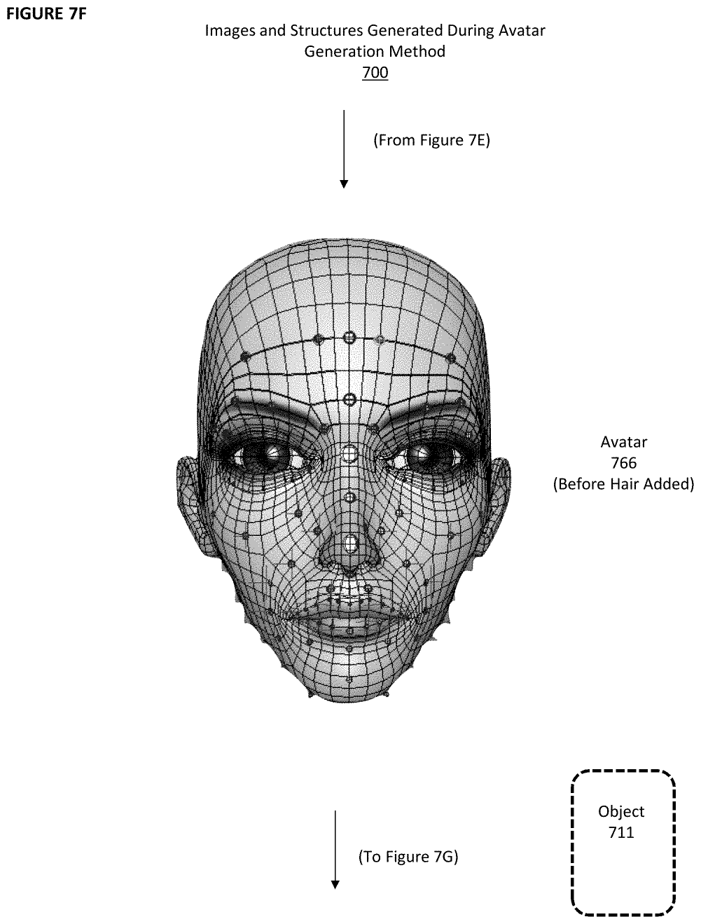

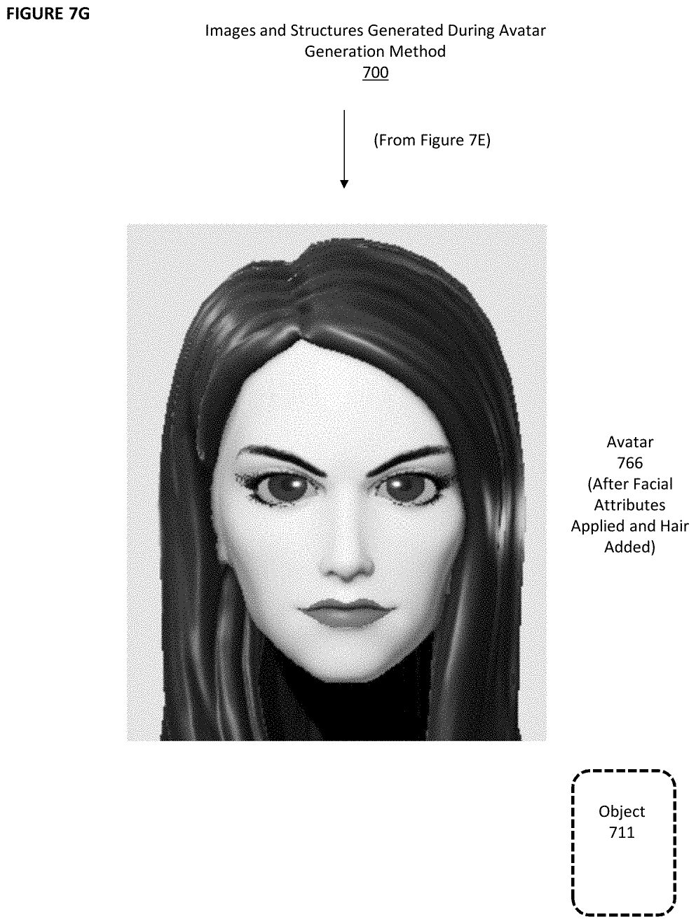

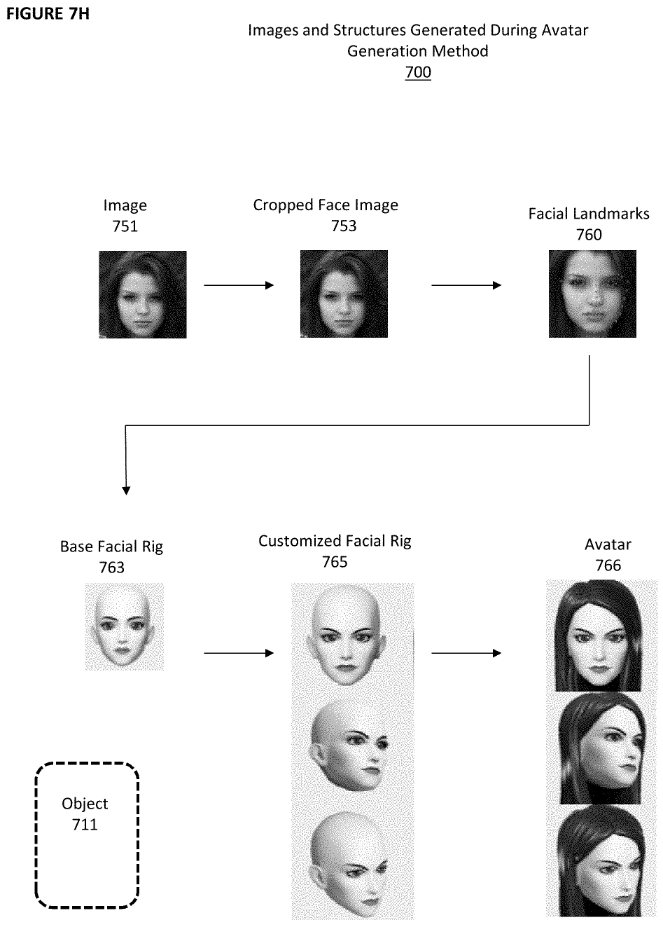

FIG. 7A depicts avatar generation method 700, which is performed by avatar generation engine 600. FIGS. 7B-7G depicts examples of images and other structures that are generated during avatar generation method 700.

With reference to FIG. 7A, avatar generation engine 600 receives image 751 (shown in FIG. 7B) (step 701). Image 751 can comprise a JPEG, TIFF, GIF, or PNG file or any other known type of image file. Image 751 optionally was generated by image capture unit 306 directly or was received by client device 300 from another device over network interface 305. Image 751 is stored in non-volatile storage 303 and/or memory 302 in client 300 and/or server 500.

Facial Detection and Normalization Module 601 identifies a face 752 (shown in FIG. 7B) in image 751 using facial detection techniques and crops image 751 to generate cropped face image 753 (shown in FIG. 7B) (step 702). Cropped face image 753 is stored in non-volatile storage 303 and/or memory 302 in client 300 and/or server 500. Object 711 is generated to store data generated during avatar generation method 700. Object 711 is stored in non-volatile storage 303 and/or memory 302 in client 300 and/or server 500.

Facial Detection and Normalization Module 601 detects head pose 754 from cropped face image 753. If head pose 754 is upright and looking at camera, the method proceeds (step 703). If not, another image is requested and steps 701-703 are repeated with a new image.

Facial Detection and Normalization Module 601 detects eye openness 755 (which can be open or closed), mouth openness 756 (which can be open or closed), and emotion 757 (which can include neutral, happy, angry, and other detectable emotions) from cropped faced image 753 (step 704). If eye openness 755 is open, mouth openness 756 is closed, and emotion 757 is neutral, the method proceeds. If not, another image is requested and steps 701-704 are repeated with a new image.

Facial Landmark Extraction Module 602 detects facial landmarks 760 (shown in FIG. 7C) in cropped face image 753 and stores facial landmarks 760 as data within object 711 (step 705).

Facial Characteristics Identification Module 603 detects ethnicity 758 and gender 759 based on cropped face image 753 and optionally stores ethnicity 758 and gender 759 as data within object 711 (step 706). Facial Characteristics Identification Module 603 optionally utilizes an artificial intelligence engine. Ethnicity 758 can comprise one or more of African, South Asian, East Asian, Latino, and Caucasian with varying degrees of certainty. Gender 759 can comprise the male gender and/or the female gender with varying degrees of certainty. One purpose of Facial Characteristics Identification Module 603 is to identify the most accurate starting point for the avatar from the set of base facial rigs 763. As state above, optionally, ethnicity 758 and gender 759 are stored in object 711. However, ethnicity 758 and gender 759 need not be stored at all (in object 711 or elsewhere), and they need not be reported to the user or any other person or device.

Facial Characteristics Identification Module 603 further detects facial attributes 761 in cropped face image 753 and stores facial attributes 761 as data within object 711 (step 707). Facial attributes 761 can comprise hairstyle, skin color, hair color, body hair, wearing eyeglasses, wearing hat, and wearing lipstick.

Rig Selection and Modification Module 604 selects base facial rig 763 (shown in FIG. 7D) from facial rigs pool 764 based on ethnicity 758 and gender 750 and stores base facial rig 763 as data within object 711 (step 708). In one embodiment, non-volatile storage 303 in client device 300 or server 500 stores facial rig pool 764, which contains one or more rigs for each gender within each ethnicity.

Rig Selection and Modification Module 604 translates, scales, and rotates joints in base facial rig 763 based on facial landmarks 760 to generate customized facial rig 765 (shown in FIG. 7E) and stores customized facial rig 765 as data within object 711 (step 709). A joint (such as joint 766 in FIG. 7D) is found at each intersection of the mesh contained in base facial rig 763.

For example, if facial landmarks 760 indicates that the distance between the center of the eyes of the face in image 751 is wider than in base facial rig 763, one or more joints (such as joint 766 in FIG. 7D) in or around each eye in base facial rig 763 can be translated (moved) in an outward direction so that the distance between the eyes is increased. These changes are stored in customized facial rig 765. Customized facial rig 765 is stored in object 711.

Mesh Generation Module 605 applies facial attributes 761 to customized facial rig 765 (shown in FIG. 7F with certain facial attributes added) to create avatar 766 (shown in FIG. 7G after all facial attributes, including hair, have been added) and stores avatar 766 within object 711 (step 710). The applied facial attributes 761 at this stage includes skin, eyes, and hair. Mesh generation module 605 creates numerous polygons (such as polygon 767 in FIG. 7E). Each of those polygons is treated as an object that can be altered to display facial attributes 761 as needed. For instance, polygon 767 in FIG. 7E corresponds to a small portion of the cheek area of the face. In FIG. 7F, that polygon has been filled in with pixels of a certain color and texture based on the skin attributes indicated in facial attributes 761.

FIG. 7H shows, on one page, an example of image 751, cropped image 753, facial landmarks 760, base facial rig 763, customized facial rig 765, and avatar 766. As shown in FIG. 7H, customized facial rig 765 and avatar 766 are three-dimensional. The same is true of base facial rig 763, although only one depiction from one viewpoint is shown in FIG. 7H. As before, the data generated during this process are stored in object 711.

Thus, avatar generation method 700 and avatar generation engine 600 are able to generate avatar 766, which closely resembles a person's face as captured in image 751. Optionally, a user can then be allowed to modify avatar 766 to his or her liking using the same types of modification controls known in the prior art. However, unlike in the prior art, the starting point for this process (i.e., avatar 766) will already closely resemble the user and will have been created with no effort or time spent by the user, other than taking or uploading a photo.

Thereafter, object 711, which includes data for avatar 766, can be replicated and stored on a plurality of client devices 300 and servers 500. Avatar 766 can be generated locally on each such client device 300 by client application 403 and on server 500 by server application 501 or web server 502. For example, avatar 766 might visually appear in a virtual world depicted on display 308 of client device 300a or on a web site generated by web server 502.

References to the present invention herein are not intended to limit the scope of any claim or claim term, but instead merely make reference to one or more features that may be covered by one or more of the claims. Devices, engines, modules, materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between).

What is claimed is:

1. A method of generating an avatar from an image of a face using an avatar generation engine executed by a processing unit of a computing device, the method comprising:
receiving the image;
identifying a face in the image;
cropping the image to generate a cropped face image;
detecting facial landmarks in the cropped face image;
detecting facial characteristics in the cropped face image, the facial characteristics comprising one or more of an ethnicity of the face, a gender of the face, hairstyle, skin color, hair color, body hair, presence of eyeglasses, presence of a hat, and presence of lipstick;
selecting a base facial rig from a set of stored facial rigs based on one or more of the facial characteristics;
altering the base facial rig based on the facial landmarks to generate a customized facial rig; and
adding facial attributes to the customized facial rig based on one or more of the facial characteristics to generate the avatar.

2. The method of claim 1, wherein the image comprises a JPEG file.

3. The method of claim 1, wherein the image comprises a PNG file.

4. The method of claim 1, where the image was generated by an image capture unit in the computing device.

5. The method of claim 1, where the image was received by the computing device over a network through a network interface in the computing device.

6. The method of claim 1, wherein the customized facial rig comprises a plurality of polygons.

7. The method of claim 1, wherein the adding step comprises filling one or more of the plurality of polygons with pixels based on skin color.

8. The method of claim 1, wherein the stored facial rigs are stored in a non-volatile storage device of the computing device.

9. The method of claim 1, wherein the stored facial rigs are stored in a non-volatile storage device of a server accessible by the computing device over a network.

10. The method of claim 1, wherein the altering step comprises one or more of translating, scaling, and rotating one or more joints in the base facial rig to generate the customized facial rig.

11. A computing device comprising a processing unit, memory, and non-volatile storage, the memory storing instructions that, when executed by the processing unit, cause the following method to be performed:
receiving an image;
identifying a face in the image;
cropping the image to generate a cropped face image;
detecting facial landmarks in the cropped face image;
detecting facial characteristics in the cropped face image, the facial characteristics comprising one or more of an ethnicity of the face, a gender of the face, hairstyle, skin color, hair color, body hair, presence of eyeglasses, presence of a hat, and presence of lipstick;
selecting a base facial rig from a set of stored facial rigs based on one or more of the facial characteristics;
altering the base facial rig based on the facial landmarks to generate a customized facial rig; and
adding facial attributes to the customized facial rig based on one or more of the facial characteristics to generate the avatar.

12. The computing device of claim 11, wherein the image comprises a JPEG file.

13. The computing device of claim 11, wherein the image comprises a PNG file.

14. The computing device of claim 11, where the image was generated by an image capture unit in the computing device.

15. The computing device of claim 11, where the image was received by the computing device over a network through the network interface.

16. The computing device of claim 1, wherein the customized facial rig comprises a plurality of polygons.

17. The computing device of claim 1, wherein the adding step comprises filling one or more of the plurality of polygons with pixels based on skin color.

18. The computing device of claim 11, wherein the stored facial rigs are stored in a non-volatile storage device of the computing device.

19. The computing device of claim 11, wherein the stored facial rigs are stored in a non-volatile storage device of a server accessible by the computing device over a network.

20. The computing device of claim 11, wherein the altering step comprises one or more of translating, scaling, and rotating one or more joints in the base facial rig to generate the customized facial rig.
